(19) United States
(12) Patent Application Publication
(10) Pub. No.: US 2025/0132915 A1
(43) Pub. Date: Apr. 24, 2025

(54) SERVICE PROVIDING METHOD AND SYSTEM USING NFT

(71) Applicants: Hyundai Motor Company, Seoul (KR); Kia Corporation, Seoul (KR)

(72) Inventor: Minhan Kim, Hwaseong-si (KR)

(21) Appl. No.: 18/894,359

(22) Filed: Sep. 24, 2024

(30) Foreign Application Priority Data
Oct. 19, 2023 (KR) 10-2023-0140589

(51) Int. Cl. H04L 9/32

(52) U.S. Cl. CPC H04L 9/3213; H04L 2209/84

(57) ABSTRACT

Disclosed is a service providing method based on a non-fungible token (NFT), which may include creating, by a system server, a hash value based on user information for a vehicle, vehicle unique information, and vehicle information, issuing, by a blockchain main net, an NFT corresponding to the vehicle by using the user information, the vehicle information, and the hash value, and performing an NFT inquiry, an NFT transaction, and metadata modification of the NFT between the blockchain main net and any personal terminal.

### CROSS-REFERENCE TO RELATED APPLICATIONS

This application claims priority to and the benefit of Korean Patent Application No. 10-2023-0140589 filed in the Korean Intellectual Property Office on Oct. 19, 2023, the entire contents of which are incorporated herein by reference.

### TECHNICAL FIELD

The present disclosure relates to a method and a system for providing a service using a real vehicle based NFT.

### BACKGROUND

Non-fungible token (NFT) is a virtual token that can prove the ownership of digital assets using blockchain technology. An address indicating digital files such as a picture, an image, etc., is contained in a token, and used as a use indicating unique originality and ownership thereof. That is, the NFT means a kind of virtual genuine certificate, as a token that is impossible to replace and has its own uniqueness and is similar to a resident registration card. The NFT permanently keeps a transaction history in a blockchain to be guaranteed with the uniqueness.

The NFT is applied to various technical fields to provide convenience to a user or can be used to provide a new value.

### SUMMARY

An embodiment of the present disclosure can provide a method and a system for providing a service capable of storing and linking various information by applying an NFT to a real vehicle.

An example embodiment of the present disclosure can provide a service providing method based on an NFT, which may include: creating, by a system server, a hash value based on user information for a vehicle, vehicle unique information, and vehicle information; issuing, by a blockchain main net, an NFT corresponding to the vehicle by using the user information, the vehicle information, and the hash value; and performing an NFT inquiry, an NFT transaction, and metadata modification of the NFT between the blockchain main net and any personal terminal.

The service providing method may further include: performing, by a personal terminal authentication for a user of the vehicle, log-in by the user on an application installed in the personal terminal; registering a vehicle unique key as the vehicle unique information through the personal terminal; uploading the vehicle information through the personal terminal; and transmitting, by the personal terminal, the user information, the vehicle unique key, and the vehicle information to the system server.

The service providing method may further include posting, by the blockchain main net, a history of the NFT on a blockchain.

The performing of the NFT transaction may include changing, by the personal terminal, an NFT owner, and transmitting a traded NFT and information on a user of the traded NFT to the system server, transmitting, by the system server, an owner change history of the traded NFT to the blockchain main net, and storing, by the blockchain main net, the NFT owner change history.

The issuing of the NFT may be performed after a start time of a production process of the vehicle.

An example embodiment of the present disclosure a service can provide a system based on an NFT, which may include: a system server for performing user authentication and confirmation through an application, and an access and use authority assignment to the authenticated/confirmed user; at least one of a personal terminal, a vehicle, and an information change platform can provide data to the system server through an off chain transaction; and a blockchain main net can receive the data processed by the system server and obtained through the off chain transaction, and apply the received data to a smart contract. The smart contract may record and/or update metadata of the NFT on a blockchain based on the received data.

When an NFT character and a user avatar are used in an environment of accessing a metaverse server through the personal terminal or the vehicle, new data generated in relation to the NFT character and the user avatar on metaverse can be provided to the system server through the personal terminal or the vehicle.

The system server may receive the new data from the personal terminal or the vehicle through the off chain transaction, and update information on the NFT character and the user avatar changed in the metaverse.

The service providing system may further include an information change platform for creating and collecting data on a vehicle history, and for providing the data to the system server through the off chain.

The data on the vehicle history may include information on tuning, an accident, and a maintenance of the vehicle.

The system server may transmit the data on the vehicle history to the blockchain main net, and the blockchain main net may apply the data on the vehicle history to a smart contract, and the smart contract may record and/or update the metadata of the NFT on the blockchain based on the data on the vehicle history.

The service providing system may further include: a provider server having an information change authority on the blockchain; and an authentication server for assigning a provider authentication key to the provider server.

According to example embodiments of the present disclosure, a method and a system for providing a service, which can store and link various information by applying an NFT can be provided.

### BRIEF DESCRIPTION OF THE DRAWINGS

FIG. 1 is a diagram illustrating an NFT issuance structure according to some example embodiments of the present disclosure.

FIG. 2 is a flowchart illustrating an NFT issuance method, according to some example embodiments of the present disclosure.

FIG. 3 is a flowchart illustrating one example of using an NFT according to some example embodiments of the present disclosure.

FIG. 4 is a block diagram illustrating a service providing system based on NFT according to some example embodiments of the present disclosure.

### DETAILED DESCRIPTION OF ILLUSTRATIVE EMBODIMENTS

In the present disclosure, the personification of a vehicle can be an operation that gives the vehicle a factor that can feel friendly like humans. The personification of the vehicle can be an action that sets details to which personal taste is reflected in the vehicle, such as naming the vehicle or creating a relevant graphic character by a future or current owner (user). When using the vehicle, a calling function of controlling the vehicle in a command stand-by state by calling the vehicle's name may be implemented for function calling. In audio, video, and navigation (AVN), an infotainment in the vehicle, a personalized character may be used as an audiovisual tool, and as a result, can allow a user to feel actually communicating. In addition, the user may create and operate a vehicle character by reflecting a taste thereof in a metaverse environment. Vehicle character generation may include a case of using a certain type of character presented from the vehicle manufacturer and/or a case of creating a new character by using an artificial intelligence (AI) application programming interface (API).

A taste or tendency of the user may be reflected to a process of selecting a specific character and a subsequent process of determining a detailed property of the character. The created vehicle character can have a shape information, the user may confirm the vehicle character through a graphic output device (e.g., a display) of a smart device or a personal computer (PC) that can implement the vehicle's infotainment (e.g., graphic output device) or a metaverse environment. The user may grant personalized elements such as voice information to the vehicle character, and may be confirmed through an output device (e.g., speaker) provided in the vehicle infotainment, a smart device, a PC, etc. Using the already provided animated database (DB), or granting concrete joints to newly created characters or customized characters, the vehicle character may be controlled to move as desired by the user depending on the situation. The vehicle character created in this way may be used when the relevant function is called in the in-vehicle AVN, a smart device, etc., when a relevant application is executed, in a metaverse environment, etc. The creation process of the vehicle character with the customer's tendency, the various services providing based on the vehicle character, and the various functions granted to the vehicle character can be inked to the functions provided by the vehicle and metaverse, which can allow the user to feel the vehicle as a similar object to the human being. This can allow the user to have a deep linkage of the real vehicle. The user can be able to use the vehicle character continuously in the user's use environment, such as a metaverse or infotainment in the vehicle.

After the production of the vehicle, the extremely personalized ceremonies may be created through the vehicle character when events such as delivery/get-on/get-off/user change/owner change. This can allow the user to form a vehicle and rapport, which may be a marketing model. The user may naturally generate attachment to vehicles and brands, and by securing as much contact points as possible, such as changing the generated vehicle character, linking with characters and vehicles, linking with characters and users, and linking characters and functions, the vehicle character may be used in an environment that crosses online and offline in addition to online, such as metaverse. In addition, the characteristics of the vehicle character connected to the actual vehicle and the histories inherent by the vehicle may be stored in the blockchain with an incompatible value. By granting an NFT token to the vehicle, the uniqueness of the only one vehicle in the world can occur, the valuable history associated with the vehicle may be preserved, and the preserved history may be created as a new value that may be traded.

In describing an embodiment disclosed in the present disclosure, a detailed description of related known technologies can be omitted if it is determined that the detailed description makes the gist of the embodiment of the present disclosure unclear. Further, the accompanying drawings are provided for helping to easily understand example embodiments disclosed in the present specification, and the technical spirit disclosed in the present specification is not limited by the accompanying drawings, and it can be appreciated that the present disclosure includes all of the modifications, equivalent matters, and substitutes included in the spirit and technical scopes of the present disclosure.

Terms including an ordinary number, such as first and second, are used for describing various constituent elements, but the constituent elements are not necessarily limited by such terms. The terms are used only to discriminate one component from another component.

It can be understood that, when it is described that a component is “connected to” or “accesses” another component, the component may be directly connected to or access the other component or a third component may be present therebetween. In contrast, when it is described that a component is “directly connected to” or “directly accesses” another component, it can be understood that no element is present between the element and another element.

In the present application, it can be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

A service system according to an embodiment of this disclosure can be available for dynamic NFT. Existing NFTs can be fixed with metadata granted when first issued. In contrast, the metadata of the dynamic NFT may be changed and the NFT may be updated. A Smart contract may change the NFT according to external conditions. For example, the smart contract may change the metadata according to the external condition change and change an image of the NFT according to a property of the changed metadata. In some example embodiments, a vehicle history, a driving history, and an owner change history can be external conditions, so that the smart contract may change the NFT according to the change of the external conditions. The changed NFT may also be applied in a metaverse environment.

The smart contract is a digital contract that exists in a software program that operates on the blockchain, and a condition required for the execution of the smart contract is set in the smart contract. The smart contract may be implemented as an application, and a processor that executes the smart contract application may be implemented by combining software and hardware, for example. Because a software program that operates on the blockchain can be executed to operate on a blockchain main net, the smart contract application may be executed in the blockchain main net. Hereinafter, when referring to at least some of the blockchains constituting the “blockchain main net” or a specific blockchain, an expression “on the blockchain” can be used.

The blockchain main net can include a chain link oracle, and all smart contracts on the blockchain may receive external data through the chain link oracle. The external data can include off chain data such as data provided from an application program interface (API) outside the blockchain. The chain link oracle may include a plurality of chain link nodes, the plurality of chain link nodes may be connected to each other through a network, and may be interfaced with outside the blockchain through an adapter. The chain link oracle may be implemented by combining software and hardware.

An NFT can include an identifier, owner information, and metadata. The identifier can include unique information for identifying the NFT on a blockchain. The owner information can include information on an owner of the NFT. The metadata may include NFT related information, e.g., information such as a writer, a title, an image description, etc. The NFT metadata according to some example embodiments may be changed according to an update such as creation, change, etc., of a vehicle character.

The NFT metadata may include information on an image, a video, an avatar (2D/3D), a character form feature, etc. (hereinafter, referred to as ‘NFT character’). The NFT character may be diversified according to selection of the owner and/or a user, and may jointly have information such as a voice, a video, animation, etc. Further, the NFT character can be modified while showing a form to which a motion, the voice, or a personalization feature is reflected other than a specific fixed form. The character feature of the NFT character can be updated, and an essence thereof can be in a real object and a stored record. The NFT character may be determined according to a recommendation provided by a metaverse operating server or as directly created by the owner and/or the user. When a new function is updated by the metaverse operating server, the NFT character may be updated by reflecting the new function. The NFT character can be utilized in a metaverse environment and a vehicle, an application in a smart device, etc., and can serve as a secretary and/or a communicator in the vehicle, an avatar in the metaverse environment, etc.

The NFT may be issued by a smart contract. The smart contract may manage issuance of the NFT, an ownership of the NFT, an NFT transaction on the blockchain, etc. The smart contract may issue the NFT in the form of an identifier based on a standard token, and store the NFT in the blockchain by an on-chain transaction. The smart contract may store metadata, a media file, etc., in an external off-chain server/database of the blockchain.

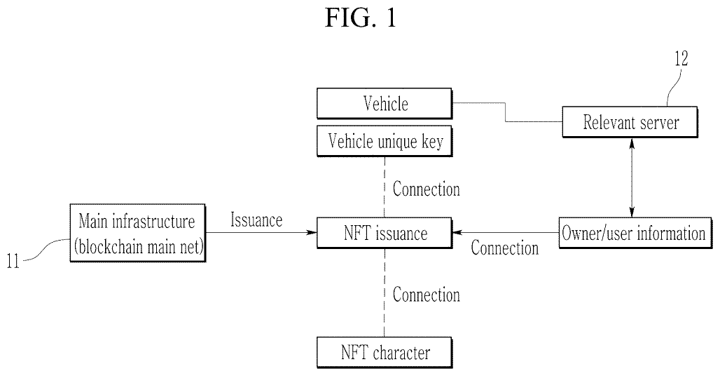

FIG. 1 is a diagram illustrating an NFT issuance structure according to some example embodiments of the present disclosure.

A blockchain main net 11, which can be a main infrastructure, may issue an NFT. The blockchain main net 11 may be based on a private or public blockchain. A smart contract on the blockchain main net 11 can be executed to issue the NFT. The NFT may be minted and issued to be connected to a vehicle unique key corresponding to a vehicle, a character (NFT character) matched with the NFT, and owner and/or user information of the vehicle. The owner and/or user information may be stored in a relevant server 12, and the NFT character as a vehicle character corresponding to the vehicle may be stored in a vehicle character related server 12. A smart contract application may load the character and the owner and/or user information from related servers through a chain link oracle. Minting and issuing the NFT, and NFT issuance may be appreciated as a same meaning.

In the present disclosure, a time when the NFT is issued is not limited. For example, the NFT for the corresponding vehicle may be issued from a start time of a vehicle production process. When a condition is satisfied in which the smart contract may be executed, such as the owner of the corresponding vehicle will be determined at the start time of the vehicle production process, unique information for the vehicle can be specified, vehicle information can exist, etc., the smart contract may issue the NFT on the blockchain from the start time of the vehicle production process. As a production process progresses, metadata of the NFT may be changed according to new information provided by the relevant server 12. A description of the following example embodiment may also be applied to NFT issuance after the start time of the vehicle production process.

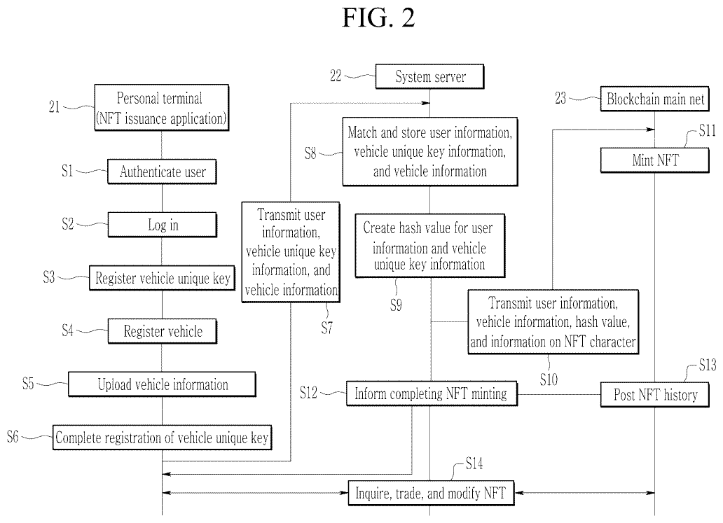

FIG. 2 is a flowchart illustrating an NFT issuance method, according to some example embodiments of the present disclosure.

A personal terminal 21, a system server 22, and a blockchain main net 23 may be connected to each other through wired and wireless networks, and may request information to each other and receive information in response to the request. In the following descriptions, “owner and/or user” can be commonly referred to as “user” and the owner can be called the owner to distinguish the owner from the user. The personal terminal can be a portable smart device, and the system server 22 indicates a server of a service system that may provide various services using the NFT.

The owner and/or user may perform user authentication using the personal terminal 21 (operation S1).

After authentication, the user may log in on the application (hereinafter, referred to as NFT issuance application) for issuing the NFT using a unique ID and a password in the personal terminal 21 (operation S2). The user may install the application and register a unique ID and a password according to a membership joining process in the application. By authentication and login, the NFT issuance application 21 may obtain information on the user.

After logging in, in response to any input of the user, the NFT issuance application 21 may register a vehicle unique key indicating a vehicle for which the NFT is to be issued (operation S3). The vehicle unique key may include a vehicle unique code, a vehicle specific serial number, and the like as an example of vehicle-specific information that may identify the vehicle.

In response to any input of the user, the NFT issuance application 21 may register the vehicle in the NFT issuance application 21 jointly with the vehicle unique key (operation S4). A vehicle number, license plate information, etc., may be used for vehicle registration.

Vehicle information may be uploaded to the NFT issuance application 21 through short-range communication (e.g., Bluetooth) between the vehicle and the personal terminal 21 (operation S5). The vehicle information may include a variety of information about the vehicle. For example, the vehicle information may include a vehicle model, a year, a production processor and a process, and a vehicle specific number.

The NFT issuance application 21 may match the vehicle unique key, the vehicle, and the vehicle information to complete registration of the vehicle unique key (operation S6). Hereinafter, the “vehicle unique key information” may include the vehicle unique key, and a variety of information matched with the vehicle unique key.

The NFT issuance application 21 may transmit, to the system server 22, the user information, the vehicle information, the vehicle unique key information, etc. (operation S7).

The system server 22 may match and store the user information, the vehicle information, the vehicle unique key information, etc. (operation S8).

The system server 22 may generate a hash value for the user information and the vehicle unique key information (operation S9). When the hash value generated by the system server 22 is different from the previous hash value, the system server 22 may recognize that the user information and the vehicle unique key information are forged. The system server 22 may post the generated hash value on the blockchain.

The system server 22 may create an NFT character that corresponds to the vehicle in a metaverse in response to the request of the owner in the manufacturing process of the vehicle. The contents described in Korean Patent Application No. 10-2023-0072198 (U.S. Ser. No. 18/509,540, filed Nov. 15, 2023) may be referred to for a method and a configuration of creating the NFT character for the vehicle by the system server 22, the entire contents of which are incorporated herein by reference. The system server 22 may set a specific NFT character as a default when there is no NFT character created in the manufacturing process of the vehicle.

The system server 22 may transmit, to the blockchain main net 23, the user information, the vehicle information, the hash value, and the information on the NFT character (operation S10).

The blockchain main net 23 can be a distribution database implemented through the network, which may mint the NFT based on the information provided from the system server 22 (operation S11). The blockchain main net 23 may receive, from the system server 22, the user information, the vehicle information, the hash value, and the information on the NFT character. The information on the NFT character may be provided to the blockchain main net 23 through a separate channel instead of the system server 22. For example, the NFT issuance application 21 may receive a vehicle character creation request from the outside (e.g., the system server, the blockchain main net, etc.), and create a vehicle character image in response thereto. The NFT issuance application 21 may transmit the vehicle character image to the blockchain main net 23, and the blockchain main net 23 may store and process the vehicle character image as the information on the NFT character.

The blockchain main net 23 may inform NFT minting completion by the NFT issuance application 21 of the user after completing the NFT minting (operation S12). The user may inquire the NFT through the NFT issuance application 21.

The blockchain main net 23 may post a history of the NFT on the blockchain after NFT mining (operation S13).

In response to any input of the user, the personal terminal 21 may inquire the NFT on the blockchain main net 23, trade the NFT, and modify the NFT (operation S14). The NFT modification may include modification of metadata granted to the NFT. In performing operation S14, the system server 22 may be involved or excluded. In the NFT transaction, the system server 22 may transmit the information received from the personal terminal 21 to the blockchain main net 23.

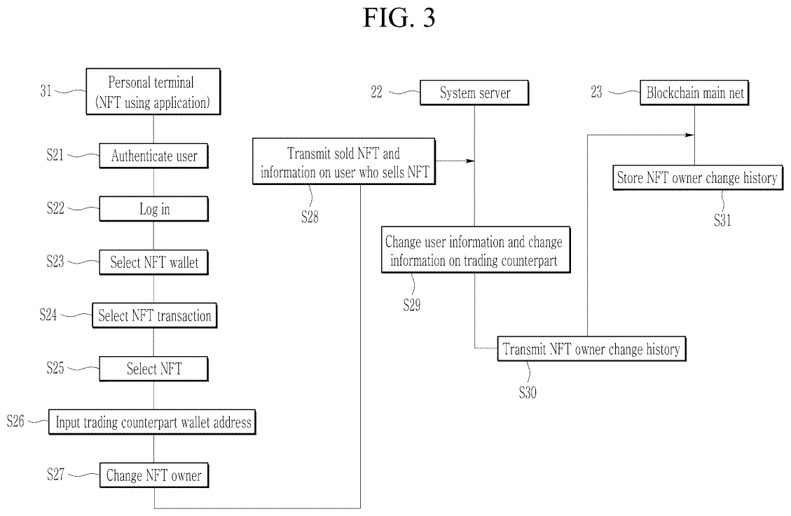

FIG. 3 is a flowchart illustrating one example of using an NFT according to some example embodiments of the present disclosure.

In FIG. 3, a method for trading the NFT is illustrated as a use example of the NFT.

First, the user may perform user authentication using the personal terminal 31 (operation S21). After authentication, the user may log in on an application (hereinafter, NFT using application) 31 for using the NFT using the unique ID and the password in the personal terminal 31 (operation S22). The user may install the application and register the unique ID and the password according to a membership joining process in the application. The NFT issuance application and the NFT using application of the above example embodiment may be integrated and implemented into one application.

In response to any input of the user, the NFT using application 31 may select an NFT wallet on the blockchain main net 33 (operation S23).

In response to any input of the user, the NFT using application 31 may select an NFT transaction among NFT using methods (operation S24).

In response to any input of the user, the NFT using application 31 may select an NFT to be sold (operation S25).

In response to any input of the user, the NFT using application 31 may receive a trading counterpart wallet address (operation S26). “Trading counterpart” can be a trading party to purchase the NFT. The counterpart can possess the NFT wallet. When the NFT transaction according to an example embodiment illustrated in FIG. 3 is performed jointly with a vehicle transaction corresponding to the NFT, the example embodiment may be performed after the vehicle transaction is completed. As such, when the user sells the vehicle of the user to the counterpart, the user may sell the NFT corresponding to the vehicle to the counterpart, and at this time, the counterpart can possess the NFT wallet. However, the present disclosure is not limited thereto, and it is also possible to trade only the NFT regardless of vehicle selling.

The NFT using application 31 may store the NFT selected in operation S25 in the received trading counterpart wallet address, and change the owner of the NFT (operation S27).

The NFT using application 31 may transmit, to the system server 22, the sold NFT and information on the user who sells the NFT (operation S28).

The system server 22 may change user information of the user who sells the NFT, and change information on the trading counterpart who purchases the NFT (operation S29).

The system server 22 may transmit an NFT owner change history to the blockchain main net 23 (operation S30). The NFT owner change history may include the information on each of the user who sells the NFT and the trading counterpart who purchases the NFT.

The blockchain main net 23 may store the received NFT owner change history in the blockchain (operation S31).

According to some example embodiments, the system server may provide various functions jointly with other components.

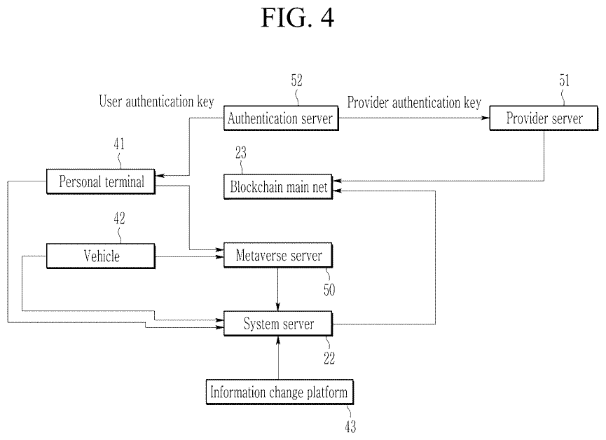

FIG. 4 is a block diagram illustrating a service providing system based on an NFT according to some example embodiments of the present disclosure.

The system server 22 may perform user authentication and confirmation through the NFT issuance application and/or the NFT using application of the personal terminal 41. The system server 22 may assign access and using authorities for the authenticated/confirmed user, and update and store relevant information when there is an event such as NFT issuance, NFT using, or vehicle information change.

In addition to the blockchain main net 23, the system server 22 may collect the relevant information from the personal terminal 41 and/or a vehicle 42, and an information change platform 43 of the user through an off chain transaction, and process the collected information. The relevant information can be information required for a processing operation of the system server 22.

For example, the user may access a metaverse server 50 through an application for using the metaverse in the personal terminal 41 such as a PC or a smartphone. Alternatively, the user may use an AVN device of the vehicle 42 to access the metaverse server 50 through a communication device of the vehicle 42. In a metaverse access environment, the user may use the NFT character, and an avatar of the user. In a metaverse, new data generated in relation to the NFT character, the user avatar, etc., may be provided to the system server 22. For example, the application provided in the personal terminal 41 may collect new data generated in the metaverse, and provide the collected data to the system server 22 through an off chain transaction. Alternatively, when the new data generated in the metaverse is data related to the NFT character and the user avatar managed by the system server 22, the metaverse server 50 may provide the data to the system server 22 through the off chain transaction. The system server 22 may update information on the NFT character, the user avatar, etc., changed in the metaverse based on the data collected through the off chain transaction.

The information change platform 43 may include servers managed by companies that may generate data on a vehicle history. For example, the companies may include maintenance companies, insurance companies, and manufacturers. When various vehicle histories generated by the information change platform 43, for example, data on tuning, accidents, and maintenance, etc., is generated, the information change platform 43 may collect the data, and provide the data to the system server 22 through the off chain transaction.

The system server 22 can process the data obtained through the off chain transaction, and transmits the processed data to the blockchain main net 23.

The blockchain main net 23 may apply the data received from the system server 22 to the smart contract, and the smart contract may record and/or update metadata of the NFT on the blockchain based on the data.

There may be a provider server 51 having an information change authority in addition to the system server 22 on the blockchain. The provider server 51 as a server operated by a provider that possesses the information change authority may be assigned with a provider authentication key from an authentication server 52. The provider server 51 can access the blockchain by using a provider authentication key to record and/or update history information for the NFT on the blockchain in the assigned authority.

The authentication server 52 may create and provide authentication keys for the provider, the user, etc. For example, when there is an authentication key request from the personal terminal 41 or the provider server 51, the authentication server 52 may create a user authentication key or a provider authentication key in response to the request, and provide the created user authentication key or provider authentication key to the personal terminal 41 or the provider server 51.

In FIG. 4, the authentication server 52 is illustrated as a separate component, but the blockchain main net 23 that issues/stores/changes the NFT may be the authentication server. Alternatively, the metaverse server 50 or the system server 22 and the authentication server 52 may be integrated and implemented into one server. Because the NFT can be issued based on a vehicle serial number, a unique code, etc., in the blockchain, the NFT may be issued, and then the user may not arbitrarily change the NFT itself, and may change the metadata of the NFT, the user information, etc. It may be possible for the provider having the authority for the information change only to input the NFT on the blockchain, and impossible to change the NFT. The owner, user, and operating/maintenance/accident history of the vehicle may be stored and notarized on the blockchain based on the NFT.

In an embodiment of the present disclosure, media information for the NFT, e.g., the NFT character can be enabled to be modified, and the NFT character may be updated according to a feature change of the vehicle corresponding to the NFT. The media information modification for the NFT and the NFT character update according to the feature change of the vehicle may be performed on the blockchain and/or the metaverse based on the information collected through the personal terminal, the information change platform, etc. For example, the vehicle operating history and vehicle fluctuation information can be stored in the blockchain in link with the NFT. Then, it can be impossible to manipulate the vehicle operating history and the vehicle fluctuation information. When the owner of the vehicle possesses the NFT and trades the NFT, the vehicle operating history, the vehicle fluctuation information, etc., linked to the NFT may be jointly traded on the blockchain, and transferred to the ownership of the counterpart that purchases the NFT. Additionally, a user or a preliminary trader specified by the owner of the vehicle may have an authority to view the NFT and the information linked to the NFT on the blockchain. The authority assigned to the preliminary trader may be temporarily limited when the owner is changed.

In an embodiment of the present disclosure, the information linked to the NFT on the blockchain may not be created by the owner. For example, in the case of the NFT, and the NFT for the vehicle, a feature of the vehicle may be created in the form of various information by various schemes, and stored in the blockchain. For example, a driving distance of the vehicle as primary information upon vehicle transaction can be one of the features of the vehicle continuously created according to the driving of the vehicle. When the feature of the vehicle is changed by an accident, information on the changed feature may be provided to the system server by an insurer and/or maintenance companies. When the feature of the vehicle is changed by tuning of the vehicle, information on the changed feature may be provided to the system server by a tuning company, a tuning product manufacturer, etc. When a failure occurs in the vehicle, a vehicle failure, and a response history such as repair or recall according to the vehicle failure may be provided to the system server by the maintenance companies, a manufacturer, etc. The vehicle failure and the response history information according thereto may be utilized for vehicle monitoring and vehicle quality improvement by the manufacturer. A vehicle feature during a production process of the vehicle may be provided to the system server by the manufacturer. When the owner is specified during the vehicle production process, the NFT and production information linked to the NFT may be immediately transferred to the owner.

In the present disclosure, the NFT may be a way of value retention. Because the NFT can be generated based on a vehicle unique key, a vehicle unique code, and a unique serial number, the NFT may show the uniqueness of the vehicle and the connectivity with the vehicle. The NFT may be traded with a vehicle transaction, and may be traded alone if the vehicle does not exist. The NFT can allow vehicle owners and/or user authentication to be authenticated, and permissions of NFT characters linked to NFT in metaverse and vehicles may be granted.

Characters corresponding to the image attribute of the NFT may help form rapport with preliminary buyers, owners, and users, and may be subject to communication. The owner can communicate with characters in a series of trends related to the vehicle, such as the purchase of a vehicle, the manufacturing process of the vehicle, and the use of the vehicle. In addition, when the owner and/or user connect to a metaverse, the vehicle, etc., the character may act as an avatar that replaces the owner/or user, and their behavior. Because the character can contain images and metadata, the owner and/or user may decorate the character as an avatar or enjoy the entertainment service through character and communication. NFTs for vehicles can be issued, and characters may be linked with NFT to build NFT characters. The owner and/or user may view the linkage with NFT and NFT through the interface between the individual terminal and the blockchain, and view the history related to the NFT on the blockchain. In this process, the NFT character may be the subject of communication.

While the example embodiments of the present disclosure have been described above in detail, it can be understood that the scopes of the present disclosure are not necessarily limited to the disclosed example embodiments, but, on the contrary, are intended to cover various modifications and equivalent arrangements included within the spirit and scopes of the appended claims.

What is claimed is:

1. A service providing method based on a non-fungible token (NFT), comprising:
creating, by a system server, a hash value based on user information for a vehicle, vehicle unique information, and vehicle information;
issuing, by a blockchain main net, an NFT corresponding to the vehicle by using the user information, the vehicle information, and the hash value; and
performing an NFT inquiry, an NFT transaction, and metadata modification of the NFT between the blockchain main net and a personal terminal.

2. The method of claim 1, further comprising:
performing, by a personal terminal authentication for a user of the vehicle, log-in by the user on an application installed in the personal terminal;
registering a vehicle unique key as the vehicle unique information through the personal terminal;
uploading the vehicle information through the personal terminal; and
transmitting, by the personal terminal, the user information, the vehicle unique key, and the vehicle information to the system server.

3. The method of claim 1, further comprising posting, by the blockchain main net, a history of the NFT on a blockchain.

4. The method of claim 1, wherein performing the NFT transaction comprises:
changing, by the personal terminal, an NFT owner;
transmitting, by the personal terminal, a traded NFT and information on a user of the traded NFT to the system server;
transmitting, by the system server, an owner change history of the traded NFT to the blockchain main net; and
storing, by the blockchain main net, the owner change history of the traded NFT.

5. The method of claim 1, wherein the NFT minting is performed after a start time of a production process of the vehicle.

6. A service providing system based on a non-fungible token (NFT), comprising:
a system server configured to perform user authentication and confirmation through an application, and the system server being configured to perform an access and use authority assignment to an authenticated/confirmed user;
at least one of or any combination of a personal terminal, a vehicle, or an information change platform being configured to provide data to the system server through an off chain transaction; and
a blockchain main net configured to receive the data processed by the system server and obtained through the off chain transaction, and the blockchain main net being configured to apply the received data to a smart contract, wherein the smart contract is configured to record and/or update metadata of the NFT on a blockchain based on the received data.

7. The system of claim 6, wherein in response to an NFT character and a user avatar being used in an environment of accessing a metaverse server through the personal terminal or the vehicle, the personal terminal or the vehicle is configured to provide new data generated in relation to the NFT character and the user avatar on a metaverse to the system server.

8. The system of claim 7, wherein the system server is configured to receive the new data from the personal terminal or the vehicle through the off chain transaction, and wherein the system server is configured to update information on the NFT character and the user avatar changed in the metaverse.

9. The system of claim 6, further comprising an information change platform configured to create and collect data on a vehicle history, and the information change platform being configured to provide the data to the system server through the off chain transaction.

10. The system of claim 9, wherein the data on the vehicle history includes data on one of or any combination of tuning of the vehicle, an accident of the vehicle, or a maintenance of the vehicle.

11. The system of claim 9, wherein the system server is configured to transmit the data on the vehicle history to the blockchain main net, wherein the blockchain main net is configured to apply the data on the vehicle history to a smart contract, and wherein the smart contract is configured to record and/or update the metadata of the NFT on the blockchain based on the data on the vehicle history.

12. The service providing system of claim 6, further comprising:
a provider server configured to have an information change authority on the blockchain; and
an authentication server configured to assign a provider authentication key to the provider server.

13. A method comprising:
creating a hash value based on user information for a vehicle, vehicle unique identification of the vehicle, and vehicle information for the vehicle;
generating a non-fungible token (NFT) associated with a vehicle by using the user information, the vehicle information, and the hash value;
storing the NFT on a blockchain, wherein the NFT is associated with a smart contract configured to record and update metadata of the NFT on the blockchain, wherein the metadata includes one of or any combination of current vehicle owner information of the vehicle, tuning of the vehicle, accident history of the vehicle, or maintenance history of the vehicle; and
updating the metadata of the NFT via the smart contract on the blockchain.

14. The method of claim 13, wherein the updating of the metadata is based on an off-chain transaction.

15. The method of claim 13, further comprising generating an owner private key for an owner of the vehicle.

16. The method of claim 15, further comprising accessing the metadata of the NFT of the vehicle on the blockchain using the owner private key.

17. The method of claim 15, further comprising trading the NFT using the owner private key.

18. The method of claim 13, further comprising generating a maintenance private key for a maintenance server provider of the vehicle, wherein the maintenance private key can be used to update metadata of the NFT on the blockchain.

19. The method of claim 13, wherein the generating of the NFT is performed at a beginning stage of production of the vehicle.

20. The method of claim 13, wherein the generating of the NFT is performed after a production process of the vehicle.
